(19) United States
(12) Patent Application Publication
(10) Pub. No.: US 2026/0182605 A1
(43) Pub. Date: Jul. 2, 2026

(54) A FEED COMPOSITION

(71) Applicant: CLONBIO GROUP LTD., Dublin (IE)

(72) Inventor: Mark TURLEY, Dublin (IE)

(21) Appl. No.: 18/857,772

(22) PCT Filed: Jun. 4, 2023
(86) PCT No.: PCT/EP2023/000031

§ 371 Date: Oct. 17, 2024

(51) Int. Cl. A23K 10/30; A23J 3/16; A23J 3/26; A23K 40/25

(52) U.S. Cl. CPC A23K 10/30; A23J 3/16; A23J 3/26; A23K 40/25

(57) ABSTRACT

The invention relates to a feed composition comprising grain and legume proteins.

The invention relates to a feed (food) composition, in particular to a protein-rich feed (food) composition useful as an additive in a human food and/or animal feed material, but also useful as a human food product and/or an animal feed product. In the following the term feed composition always includes the term food and vice versa, if not explicitly excluded.

Numerous attempts have been made in the past to provide such feed compositions rich in protein. Corresponding patent applications refer—inter alia—to the recovery of proteins, e.g. from a distillation process.

EP3164410B1 discloses such a process, using the liquid residue that remains in a wash after distillation, the so-called “pot ale”, often still featuring around 20% by weight proteins as dry matter, which then is allowed to settle before mechanical recovery.

GB2493547A also refers to protein recovery, namely from an ethanol fermentation process.

A different process for recovering a protein-containing material is disclosed in EP2410869B1.

In terms of protein yield, all these methods are limited and do not allow commercially attractive products. According to Belyea et.al. [“Composition of corn and distillers dried grains with solubles from dry grind ethanol processing” published in Bioresource Technology 94 (2004) 293-298; online available on 1 Jun. 2022 at www.sciencedirect.com] the protein content of DDGS (distillers dried grains with solubles) can range from 27-35%.

According to U.S. Pat. No. 11,634,461 B2, column 2, lines 1-4, soy based protein isolates can reach protein concentrations of 70-90%, but food products based on such soy proteins do not feature acceptable texturization and/or functionality. For example their water holding/absorption capacity WAC (in gram water per gram protein isolate) is far above 5, their chewiness is low (often <30 mJ) and the products often do not reach bulk densities >100 kg/m³, thus limiting their use.

Important factors of food proteins and protein containing food products are texturization and functionality, although both are not yet fully studied and standardized [“Physiochemical and Functional Properties of Texturized Vegetable Proteins . . . ”; Foods 2022, 11(17), 2619; online available https://www.mdpi.com/2304-8158/11/17/2619 on 23 May 2023, hereinafter referred to as FOODS].

While nutritional properties affect the human or animal body after consumption, textural and functional properties characterize food and/or food ingredients prior to entering the body.

Typical functional features are: water holding/absorption capacity (WAC) and oil holding/absorption capacity (OAC), defining the maximum amount of water or oil/fat respectively in gram per gram of the solid protein material.

A definition of texture in food products and methods to define the texture in food products may be found in: https://www.sciencedirect.com/topics/food-science/food-texture?msclkid=a9f038a2d14011eca95e33c8ac5e749f; online available on 1 Jun. 2022.

Although reliable standards to determine the texture of food products have not yet been made available, the following categories, based on human sensorics, are widely used [ref. Szczesniak, A., Classification of Textural Characteristics; Journal of Food Science 28, 981-985 (1965)] and have proven to be sufficiently accurate.

Primary characteristics

| | |
|---|---|
| Hardness | soft→firm→hard |
| Cohesiveness | crumbly→chrunchy→brittle |
| Elasticity | plastic→elastic |
| Adhesiveness | sticky→tacky→gooey |
| Viscosity | thin→viscous |

Secondary characteristics

| | |
|---|---|
| Brittleness | crumbly→chrunchy→brittle |
| Chewiness | tender→chewy→tough |
| Gumminess | short→mealy→pasty→gummy |

A “good” texturization (structure) of food and food compositions is an important factor with respect to the acceptance in particular by human consumers. For example certain food products, like protein bars, should present a certain “bite”. Consumers associate a certain structure (texturization) for meat, which is expected to be similar for so called meat analogues (food products replacing meat) including proteins.

According to prior art, mentioned above, the said protein containing residues of a fermentation plant typically present a small grain size (often with a d₅₀ value<1 mm) or even a powder form (often with a d₅₀ value between 50 and 500 μm), correspondingly a large surface area, which makes it difficult to prepare these proteins as suitable food bites with a required texture, in particular without using further additives like binders.

Another disadvantage of known protein products is their rheological behaviour. When made up as a powder they can be used as an ingredient (additive) in other food preparations. While the dosage is arbitrary and may lead to under or over dosages, such protein products vary their rheological behaviour characteristically when mixed with a fluid, in particular due to their high fluid (=water) holding capacities, typically larger than 5 times the weight of the solid material.

In light of this background, it is an object of the invention to provide a feed composition, rich in protein and presenting favourable texturization and functionality features to allow use of the product as such and/or as a substitute and/or ingredient and/or batch component in other food products. A further target of the invention is to make the composition and its production method sustainable.

The invention is based on the following findings and makes the following main approaches:
Provision of a product deriving from a blend of various protein components; in other words: the combination of at least a first and second component, both rich in protein and to transfer the corresponding mixture (blend) into suitable foot bites with the desired and required texture.
While the first component is a grain based component and free of fermentation constituents (fermentation ingredients), the second component is selected from legumes.
The blend requires certain parts by weight of both components to achieve a product presenting the desired features.
The components must be brought into intimate physical contact to provide the desired texture and functionality of the final feed composition.

The first component is a grain based concentrate of at least 60% by weight protein and further characterized by the lack of fermentation ingredients. Insofar it differs completely from the barley protein concentrate known from U.S. Pat. No. 8,481,677B2, which protein product is a direct product of the fermentation of carbohydrates in the grain.

The specific selection of a grain protein concentrate which hasn't undergone previous fermentation steps of the grain does not exclude the use of a grain protein from a superordinate or additional process, including a process to produce bio-ethanol from grain, which typically includes a fermentation step. In such case the fermentation will be arranged downstream of the process step in which the grain protein is extracted from the additional (co-) process. Reference is made to U.S. Pat. No. 11,634,461B2 which discloses a corresponding process to produce a barley (grain) protein concentrate (BPC) without any fermentation ingredients. This BPC may be used as a first component within the new feed composition.

Preferred suitable grains besides barley include corn (maize), wheat, rye, rice and triticale as well as mixtures thereof, which can be treated in the same way.

The invention makes binders etc. dispensable, but adds a second component selected from proteins deriving directly from legumes, wherein said second component consists of at least 50% by weight proteins (on a moisture free basis). Within the new composition the term legumes also covers oilseed or a mixture of legumes and oilseeds. Such protein components react synergistically with the (mostly powder-like) grain protein concentrate to feature texturization capabilities.

An important and surprising perception during the development of the new feed composition indeed was that the combination (mixture/blend) of these two components (first component, a certain grain protein concentrate, which first component consists of at least 60% by weight proteins and does not include fermentation constituents; second component selected from legumes, which second component consists of at least 50% by weight proteins) changes the texturization capability of both components within said mixture and during manufacturing of the final product dramatically in a favourable direction with respect to its intended use. Mechanical interactions between the “2 phases” (2 components), in other words: mechanical crosslinks between the two components can be generated to give the final product the desired texture. Simultaneously the new feed composition presents improved functionality features, in particular a characteristically reduced WAC, which allows to produce and provide completely new protein based food analogues.

During intensive trials it was further observed that this synergistic behaviour (effect) is limited to certain percentages of the two components within the blend.

This effect is supported by a selection of technologies to blend (mix) the two components: Mixing with a common “hand blender” (immersion blender) allows the two components to be homogeneously distributed, the structure of the overall final product is better than in prior art mentioned but still relatively weak as is the density, hardness etc.. Significantly better results can be achieved if the distribution and contacting of the components are carried out on a pelletizing plate or an adequate pelletizing machine. Such pelletizing means are known in the art, although for different applications like pelletizing of ceramic materials.

Best results can be achieved with the help of an extruder. The starting materials (components) are typically fed into the extruder together with water and steam, then mixed and compacted along an extruder channel, often with the aid of a screw like feeding means, and the extruded, homogeneous mass is cut at the exit of the extruder channel. The size of the machine parts, the amount of water and steam, the rotational speed of the screw (spindle), thus the throughput rate and other machine and material parameters allow to adjust the “mixing process” in a customized manner. Accordingly the density of the extruded material, its texture, porosity etc. may be adjusted precisely and in a bespoke way.

The protein containing components (materials) may be treated within the extruder at temperatures above 100° C., above 150° C. or even above 200° C. In particular at temperatures above 150° C. the texturization capability between the protein containing components (ingredients) increases favourably.

An extruded feed composition is a preferred embodiment of the invention. The extruded material stream can be further processed, for example by cutting means, by adding air into the product etc.

Reliable results were achieved with the first component of between 25% and 65% by weight and the second component of between 75% and 35% by weight, with both adding up to at least 95% by weight of the final food composition (the final product, always calculated on a moisture free basis).

Best results were based on the following parts per 100 parts of the final product [table1]:

| | first component | Second component |
|---|---|---|
| Sample | (by-product), each≥ | (protein), each≤ |
| A | 30 | 70 |
| B | 40 | 60 |
| C | 50 | 50 |
| D | 60 | 40 |

Within these ranges the following options could be identified:
The bulk density of a feed composition, in particular an extruded feed composition, increases with higher percentages of the grain protein concentrate. While bulk densities of the final product between 100 and 300 kg per cubic meter were achieved over the full range, higher bulk densities of ≥125 kg/m³ or ≥150 kg/m³ and in particular between 130 and 280 kg/m³ often require more than 50% by weight of the grain protein concentrate and allow numerous new applications.
the new feed composition leads to strongly reduced water holding (absorption) capacities of the final product, in particular down to <3 g water per g feed composition, even to less than 2,3 g water per g feed composition within the given ranges of the first and second component.
Compared with a protein product solely made from legumes like soy, the new product provides a substantial higher chewiness, with increases in chewiness of >100% being possible.
The higher the percentage of the grain protein concentrate within the blend, the higher gets the chewiness (mJ) of the final food product.
Samples including more than 65% by weight of the grain protein concentrate do not lead to further improved texturization and functionality features, to the contrary: a decrease in hardness and chewiness could be observed.

It was also noticed that the emulsification performance of the new feed composition is mainly influenced by the second component, deriving from legumes, independently of the respective pH value. Accordingly feed compositions requiring high(er) emulsification performance will comprise percentages of the legumes component at the upper end of the claimed range, e.g. 60-75% by weight.

At least one of the first component and the second component may be composed of more than one ingredient (basic material). For example the first component can be composed of two or more proteins from more than one grain, for example barley and rye protein components.

Similarly the second component can be made of proteins deriving from two or more different legumes, for example soy, lentil and pea proteins.

Both components have been processed from the basic grain(s) and legume(s) into a protein concentrate or protein isolate, depending on the protein content required.

Analysis by means of a microscope confirmed that the addition of the second component to the first component within the given ranges causes a dramatic change of texture within said blend. The two components act with each other as a texture modifier for the final food composition.

By the addition of legume proteins mechanical bridges are built between adjacent particles of the first and second components, giving the overall product the desired textural, functional properties, including physical like haptic properties.

This change in structure is also responsible for a completely different water hydration of the products compared with powdery protein products following prior art and allows new and further food preparations and applications.

In its most general embodiment, the invention relates to a feed composition according to claim 1, i.e. a feed composition, comprising the following features:
an intimate blend of
25 to 65% by weight of a first component, being a grain protein concentrate free of fermentation constituents, which first component consists of at least 60% by weight proteins,
35 to 75% by weight of a second component, directly deriving from legumes, which second component consists of at least 50% by weight proteins, wherein
the first and second component
add up to at least 95% by weight of the feed composition and
are mechanically linked (interconnected) to each other, thereby creating a texturization within the feed composition and making it dimensionally stable.

The term “grain” includes grains such as corn (maize), wheat, barley, rice, triticale and rye as well as mixtures thereof.

The feed composition can be made-up as a dry product, a wet product or a product of medium moisture content.

A dry product is characterized by a solid structure and texture and a maximum moisture content of 10 parts by weight per 100 parts by weight of the (dry) solid components of the feed composition. The new feed composition allows to reduce the moisture content to <5 parts, even <3parts by weight per 100 parts by weight of the solid components of the feed composition. In other words: A dry product has a moisture content of less than about 9% by weight, according to an embodiment of less than 3% by weight.

A wet product is characterized by a soft, meat like structure and texture and a minimum moisture content of 100 parts by weight (or even more than 130 parts by weight) per 100 parts by weight of the (dry) solid components of the feed composition. In other words: the moisture content of a wet product is at least 50% by weight, according to an embodiment higher than 55% by weight and may be even higher than 60% by weight or 65% by weight.

A product of medium moisture content has a moisture content in between a dry and a wet product.

The upper and lower weight limits of the two components within the blend may be set in accordance with table 1.

The protein content of the first component can be higher than 60% by weight, for example ≥65% by weight or ≥75% by weight or even ≥90% by weight, depending on the pre-treatment of the grain component.

A suitable method (process) to produce a grain protein concentrate (the following example refers to the production of a barley protein concentrate) without any fermentation steps may include the following steps:
a) dehulling of barley to remove hulls and husks
b) grinding to obtain a barley flour of a particle size d₈₀<800 μm, in particular <500 μm
c) dissolving the barley flour in water under the addition of an enzym to produce a slurry, containing solubilized carbohydrates, and liquefaction of the slurry, at increased temperature [60-90° C.]
d) further addition of enzymes under continuous agitation with a processing time of several hours
e) separation of solid fibres from the liquid phase including the proteins, e.g. by centrifugation
f) drying of the liquid protein fraction, optionally including disintegration to achieve a homogeneous particle size distribution, until the requested final moisture content is achieved.

This method is primarily characterized by various subsequent mechanical disintegration (separation, sorting) steps of the basic grain material and supplemented by a biochemical step (like an enzymatic intervention), inter alia to remove starch (in particular) from the grain material.

Disintegration of the basic grain material by mechanical means is easy to perform with common equipment like mills (ball mills, hammer mills), rippers (cyclones, centrifuges) etc.

Suitable enzymes are alpha amylase (available, inter alia, under the brand “Optimash”), glucoamylase, hemicellulose and phytase.

Optionally sugars within the liquid phase of step e) may be removed by an additional separation step, which makes the process further sustainable.

By this method the grain protein is isolated through mechanical and biochemical (in particular enzymatic) means into a protein concentrate (at higher protein % also referred to as a barley protein isolate) after enzymatic hydrolysis. It does not require harsh solvents or other chemicals. Enzymatic hydrolysis is a preferred method to produce the first component, the grain protein material. The corresponding grain protein concentrate/isolate typically has a pH>5.

Along with said process the soluble non-protein grain components can be separated and valorized into foods, feeds, biomaterials, biochemicals and/or fuels.

The described process, which is free of any fermentation step, also allows use of the non-protein fractions and phases (after separation of the proteins) within a bioethanol production plant, then including a fermentation step and thus making the overall process even more sustainable.

Insofar sustainability can be achieved by adapting known methods and technologies. This reduces or even avoids the construction of new machinery, the exploitation and consumption of additional raw materials, the use of energy and associated emissions, etc. It may even avoid any direct landfill as far as by-products (or even wastes) of known production methods, which were disposed of in the past, can now be used for preparing further products.

Sustainability can also be achieved by shifting from food and feed sources produced in areas of high rates of deforestation to food and feed sources in areas without deforestation. For example, the global trade of soy and soy products has a clear nexus to deforestation in some areas, whereas barley has no such nexus. Likewise, sustainability can be achieved by shifting from crops with low productivity per hectare to crops with high productivity. Most grain crops produce more protein per hectare than crops like peas, even though peas have a higher protein content per ton of product. As biorefineries become more widespread, basic plant components like starch, protein, fat and fiber can be refined separately into food, feed, biomaterial, fuel and biochemical final products, leaving nothing to waste,

The second component is a legume product, which is available in the market as such and which features at least 50% by weight proteins. Typically it is made up as a dry powder. As an example: a soy protein characterizes the proteins of soy beans and can comprise products of high protein content, including, inter alia, de-oiled soy flour, a so-called soy protein concentrate and/or a so-called soy protein isolate.

Many such plant proteins, in particular legume proteins, have substantially equivalent amino acid concentrations as animal proteins, which makes them even more attractive.

The new feed composition (food preparation) is based on the two components mentioned. It does not require any further additives like binders, colorants, tensides etc.. Insofar the two components may add up to 100% by weight of the final composition and so be considered a “clean label” alternative protein product.

Nevertheless the invention does not exclude small parts of other ingredients like vitamins, inert additives like perlite, vermiculite, impurities etc. or flavorings, in particular those which do not influence the desired overall behaviour of the new composition (formulation, product, texture) in a negative way and/or adds substances of different mechanism.

Typically the percentage of such optional additives will not exceed 5% by weight, in other preferred embodiment being ≤4%, ≤3%, ≤2%, ≤1% by weight (all based on the dry final product).

Based on these two components the feed composition may comprise one or more of the following amino-acids:
aspartic acid, threonine, serine, glutamic acid, proline, glycine, alanine, cysteine, valine, methionine, isoleucine, leucine, tyrosine, phenylalanine, histidine, lysine, arginine.

The final product can be prepared in different make-ups, as a bar, a pop-corn like material, a granola-type product, a meat-like product etc., all featuring the texturization desired for the respective make-up.

Barley as a first component is a crop maturing before other grains and available in irrigated as well as in dry land areas, it is relatively resistant to various environmental influences like rain, frost etc. and favourable due to its availability, price, regrowing properties and—in particular—its protein content.

The chemical composition of a suitable barley protein concentrate (BPC), depending on the growing conditions of the barley grain and the method to produce the concentrate from the basic grain material, is given as:
protein: 60-80, in particular 62-75
ash: 0,5-4, in particular 1-3
moisture: 6-10, in particular 7,5-9,5
fat: 0,5-12,5, in particular 2-10
total carbohydrate: 10-27, in particular 12-24
crude fibre: 1-8, in particular 2-8
   (all % are weight %)

Use of a BPC of a particle size (d₈₀)<500 μm is advantageous. Particle sizes of 300 to 500 μm can lead to a foaming capacity (FC) of about 18%, while the FC may increase to about 42% for a BPC presenting a particle size (d₈₀) of 100-200 μm. Corresponding methods to determine FC, a further functionality feature, are described by Wu, H.; Wang, Q.; Tiezheng, M.; Ren, J. Comparative Studies on the Functional Properties of Various Protein Concentrate Preparations of Peanut Protein. Food Research International 2009, 42, 343-348.

As mentioned above the texture of the final product is decisive, wherein the following data may be achieved within a new product:
hardness [N]:>10
adhesiveness [mJ]: 0,01-0,3
chewiness [mJ]: >50

The feed composition may provide at least one functionality parameter of the group comprising:
water absorption capacity (WAC): <4 g water per 1 gram of the feed composition
oil absorption capacity (OAC): <2 g oil per 1 gram of the feed composition
foaming capacity (FC): >40%
foam stability: >50%.

Reference is made to FOODS, in which corresponding methods to determine the respective parameters are disclosed. WAC and OAC are discussed in § 2.4 of FOODS, rehydration capacity (liquid absorption of the final feed composition) in 2.5.

The water holding/absorption capacity WAC (wherein water stands for any type of a fluid/liquid) of the final product is an important feature with respect to its use.

Common protein products feature a water holding capacity of more than 6 times the weight of the solid material. This limits their use and applications in many ways.

The new formulation (feed composition) reduces the amount of water absorbed by the product dramatically; with less than 4 parts by weight fluid (in particular water) per part of the final product. Relations of <1:3, <1:2,5, <1:2,2, even <1:2 are achievable, depending on the particle size and respective amounts of the two components.

A WAC of less than 4 g of water per 1 g of protein (dry matter) can be achieved using a Barley protein concentrate BPC in powder (flour) form, featuring a particle size d₈₀ smaller than 500 μm. The smaller the particles the lower the WAC, with a WAC of <3,0 or even <2,5 g water per 1 gram protein in case of use of a powder featuring a d₈₀ value of <300 μm or <100 μm respectively. Insofar the WAC of the BPC as well of the final product can be adjusted by varying the grain size of the BPC and/or by varying the method steps in combining the two components to provide the final product. Although the grain size of the BPC changes during further treatment, in particular during mixing and extruding, the effect described remains valid.

For products requiring a higher WAC a BPC featuring grains of >500 μm (d₈₀ particle size) can be selected.

Similarly it was found that the oil holding/absorption capacity (OAC) of the barley protein concentrate decreases in case of fine grains and being <2 g oil per g protein in case of a BPC powder with a d₈₀ particle size value smaller than 500 μm, which further decreases in case of powders with a d₈₀ value of <300 μm and <100 μm respectively, wherein the OAC can reach values of <1,5. To the contrary: in case of feed products requiring higher OAC a BPC should be used featuring larger grains, in particular grains of >500 μm (d₈₀ particle size).

The invention provides further options and improvements:

The feed composition may comprise a grain as a first component, that has been treated, in particular disintegrated and/or sorted by mechanical means and/or by a biochemical treatment, in particular a grain, that has undergone an enzymatic treatment (intervention).

The so-called hydration time of the new feed composition can be less than 30 minutes, being the time to achieve at least 90% of its maximum water hydration (=water absorption=rehydration capacity). Various experiments with the new feed compositions disclosed hydration times of less than 20 min, or even less than 10 min.

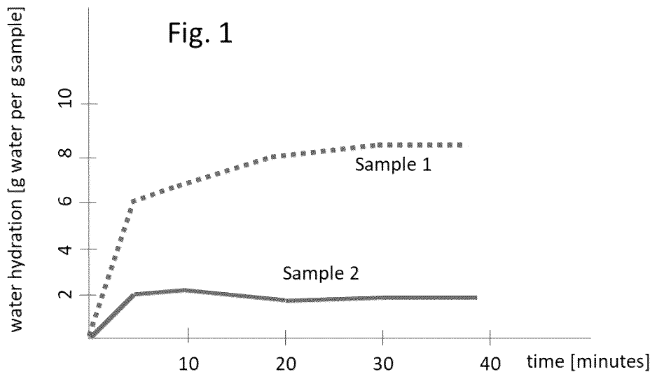

FIG. 1 displays the fundamental differences between a new extruded feed composition [sample 2] based on 40% by weight barley protein concentrate and 60% by weight soy protein and a 100% soy protein product [sample 1].

The new product allows various preparations: As examples it can feature a popcorn-like structure with a high total porosity (open and closed pores), e.g. of more than 50% by volume, as well as a more dense, but chewy texture (similar to meat); pasta-like make-ups with moisture contents of around 2-4% by weight are also within the scope.

Further examples of intended use are a burger patty and meat chunks where the use of the new texturized vegetable protein (TVP) with a lower WAC (<4) can be leveraged in contrast to the spongy nature of a TVP with high WAC (>4) according to prior art. The new configuration allows to formulate the composition adequately with respect to its intended use.

Further features of the invention may be derived from the claims as well as the other application documents. These features may be combined in any way if not explicitly excluded or technically unreasonable.

1. A feed composition featuring
1.1 an intimate blend of
1.1.1 25 to 65% by weight of a first component, being a grain protein concentrate free of fermentation constituents, which first component consists of at least 60% by weight proteins,
1.1.2 35 to 75% by weight of a second component, directly deriving from legumes, which second component consists of at least 50% by weight proteins, wherein
1.2 the first and second component
1.2.1 add up to at least 95% by weight of the feed composition and
1.2.2 are mechanically linked (interconnected) to each other, thereby creating a texturization within the feed composition and making it dimensionally stable.

2. The feed composition of claim 1, providing a solid structure and a maximum moisture content of 10 parts by weight per 100 parts by weight of the solid components of the feed composition.

3. The feed composition of claim 1, providing a soft structure and a minimum moisture content of 100 parts by weight per 100 parts by weight of the solid components of the feed composition.

4. The feed composition of claim 1, wherein the second component is selected from a group comprising soy, lentil and pea, as single component or in mixtures.

5. The feed composition of claim 1, wherein the first component is selected from a group comprising barley, rye, wheat, rice, corn and triticale, as single component or in mixtures.

6. The feed composition of claim 1 featuring at least one texturizing parameter of a group comprising:
6.1 hardness [N]:>10
6.2 adhesiveness [mJ]: 0,01-0,3
6.3 chewiness [mJ]: >50

7. The feed composition of claim 1, featuring a bulk density of between 100 kg and 300 kg per cubic meter of the feed composition.

8. The feed composition of claim 1, featuring at least one functionality parameter of the group comprising:
8.1 water absorption capacity (WAC): <4 g water per 1 gram of the feed composition
8.2 oil absorption capacity (OAC): <2 g oil per 1 gram of the feed composition
8.3 foaming capacity (FC): >40%
8.4 foam stability: >50%.

9. The feed composition of claim 1 featuring a hydration time of less than 30 minutes to achieve at least 90% of its maximum water hydration (absorption).

10. The feed composition of claim 1, wherein at least 80% of the first component have a particle size of less than 500 μm.

11. The feed composition of claim 1, wherein the first component comprises a grain, that has been disintegrated by mechanical means.

12. The feed composition of claim 1, wherein the first component comprises a grain, which has undergone a biochemical treatment.

13. The feed composition of claim 12, wherein the first component comprises a grain, which has undergone an enzymatic treatment.

14. An extruded feed composition according to claim 1.
